(19) United States
(12) Patent Application Publication
(10) Pub. No.: US 2013/0126277 A1
(43) Pub. Date: May 23, 2013

(54) TIMER FOR SHABBAT ELEVATOR

(71) Applicant: Steven Elliot Friedman, Jerusalem (IL)

(72) Inventor: Steven Elliot Friedman, Jerusalem (IL)

(21) Appl. No.: 13/300,685

(22) Filed: Nov. 21, 2011

(51) Int. Cl. B66B 1/20

(52) U.S. Cl. 187/384

(57) ABSTRACT

Apparatus and methods are provided for use with a Shabbat-elevator inside a building, including an elevator transmitter configured to be placed in a vicinity of the elevator and to transmit a signal. At least one repeater is placed on a given floor of the building, the repeater including a receiver that is configured to receive the signal from the transmitter, when the elevator is at the given floor. A control unit is configured, in response to the signal, to determine a time interval until the elevator is predicted to next be at the given floor. A display unit displays an indication of when the elevator is predicted to next be at the given floor, based upon the determined time interval. Other applications are also described.

### FIELD OF EMBODIMENTS OF THE INVENTION

Some applications of the present invention generally relate to apparatus for use with a Shabbat elevator. Specifically, some applications of the present invention relate to timer systems for use with Shabbat elevators.

### BACKGROUND

From sunset on Friday evening, until Saturday night, practicing orthodox Jews observe the Shabbat (Hebrew for Sabbath). Under usual circumstances, on Shabbat it is forbidden for Shabbat-observers to close an electrical circuit. Therefore, it is forbidden for Shabbat-observers to operate an elevator in the usual manner, i.e., by calling the elevator by pressing a button, and designating the floor to which the elevator should travel by pressing a second button. Similarly, it is forbidden for practicing orthodox Jews to operate an elevator in the usual manner on certain Jewish festivals.

In many buildings in Israel, the USA, and elsewhere, in which Shabbat-observers reside, one or more Shabbat-elevators are operated on Shabbat and Jewish festivals. A Shabbat-elevator is an elevator that is programmed to automatically stop on designated floors of a building, in accordance with a fixed cycle. For example, the elevator may stop in the lobby of a building for a designated time period (e.g., one minute), in order to allow people to enter the elevator. During its ascent, the elevator may stop on every floor (or selected floors) of the building for designated time periods (e.g., half a minute on each floor), before descending from the top floor to the lobby without stopping on the way. Alternatively or additionally, during its descent, the elevator may stop on every floor (or selected floors) of the building for designated time periods (e.g., half a minute on each floor).

### SUMMARY OF EMBODIMENTS

For some applications of the present invention, a timer system is configured for use with a Shabbat-elevator. The timer system is configured to display on display units the time intervals until the elevator will next arrive at respective floors of the building (typically, in the form of countdown timers). Typically, one or more of the display units are placed on each floor of a building (e.g. inside of apartments of the building and in the lobby).

Typically, a transmitter that transmits a signal is placed in the vicinity of the elevator (e.g., inside the elevator, or on the roof of the elevator). At least one repeater is placed on a given floor of the building, the repeater being configured to receive the signal from the transmitter, when the elevator is at the given floor. Typically, a plurality of repeaters are placed on respective floors, the repeaters being configured to receive the signal from the transmitter, when the elevator is at corresponding respective floors. In response to the signal, a control unit determines a time interval until the elevator will next be at the given floor. A display unit displays an indication of the time interval (e.g., by displaying a countdown timer). Typically, display units are placed in the lobby of the building, in apartments of the building, and/or in the vicinity of the elevator door on each floor of the building.

There is therefore provided in accordance with some applications of the present invention, apparatus for use with a Shabbat-elevator inside a building, the apparatus including:

an elevator transmitter configured to be placed in a vicinity of the elevator and to transmit a signal;

at least one repeater configured to be placed on a given floor of the building, the repeater including a receiver that is configured to receive the signal from the transmitter, when the elevator is at the given floor;

a control unit configured, in response to the signal, to determine a time interval until the elevator is predicted to next be at the given floor; and

a display unit configured to display an indication of when the elevator is predicted to next be at the given floor, based upon the determined time interval.

For some applications, the elevator includes an elevator that stops at the given floor a single time in an up-down cycle of the elevator, and the control unit is configured to estimate the time interval until the elevator that stops the single time is predicted to next be at the given floor.

For some applications, the elevator includes an elevator that stops at the given floor twice in an up-down cycle of the elevator, and the control unit is configured to estimate the time interval until the elevator that stops twice is predicted to next be at the given floor.

For some applications, the display unit is configured to display a timer that counts down to an estimated time of the next arrival of the elevator at the floor.

For some applications, the transmitter is configured to transmit the signal by transmitting a short-range signal that is such that the repeater only receives the signal when the elevator is on the given floor.

For some applications:

the control unit is operatively coupled to the display unit,

the repeater is configured to transmit a signal to the display unit indicating that the elevator is at the given floor; and

the control unit is configured to receive the signal and estimate the time interval until the elevator is predicted to next be at the given floor, in response thereto.

For some applications:

the control unit is operatively coupled to the repeater,

the transmitter is configured to transmit the signal by transmitting a signal indicating that the elevator is at the given floor,

the repeater is configured to receive the signal, and the control unit is configured to estimate the time interval until the elevator is predicted to next be at the given floor, in response thereto; and

the repeater is configured to transmit an encoded signal to the display unit, the encoded signal containing an indication of when the elevator will next be at the given floor.

For some applications, the repeater is configured to amplify the encoded signal and transmit the amplified encoded signal to the display unit.

For some applications, the repeater includes a plurality of repeaters disposed on respective floors of the building.

For some applications, the repeaters of the respective floors are configured to transmit signals having respective signal parameters, and the display units of a given floor are configured to receive signals having parameters that correspond to the signal transmitted by the repeater on the same floor as the display units.

For some applications, the control unit is configured to determine the time interval by calculating a time interval between consecutive previous arrivals of the elevator at the floor.

For some applications, the control unit is configured to determine a characteristic elevator cycle time based upon a plurality of time intervals between respective, consecutive arrivals of the elevator at the floor, and the control unit is configured to determine the time interval until the elevator is predicted to next be at the floor, based upon the characteristic elevator cycle time.

For some applications, the control unit is configured to determine the characteristic elevator cycle time by determining a mean time interval of the plurality of time intervals.

For some applications, the control unit is configured to determine the characteristic elevator cycle time by determining a minimum time interval of the plurality of time intervals.

There is further provided in accordance with some applications of the present invention, a method for use with a Shabbat-elevator inside a building, the method including:

in response to the elevator arriving at a given floor of the building, receiving a signal;

in response to receiving the signal, determining a time interval until the elevator is predicted to next be at the given floor; and

displaying an indication of when the elevator is predicted to next be at the given floor, based upon the determined time interval.

There is additionally provided, in accordance with some applications of the present invention, a method for use with a Shabbat-elevator inside a building, the method including:

receiving a signal that is indicative of the elevator having arrived at a given floor of the building;

in response to receiving the signal, determining a time interval until the elevator is predicted to next be at the given floor; and

displaying an indication of when the elevator is predicted to next be at the given floor, based upon the determined time interval.

For some applications, determining the time interval includes determining the time interval even without accessing an operating system of the elevator.

The present invention will be more fully understood from the following detailed description of embodiments thereof, taken together with the drawings, in which:

### BRIEF DESCRIPTION OF THE DRAWINGS

FIG. 1 is a block diagram of a timer system for use with a Shabbat elevator, in accordance with some applications of the present invention;

FIG. 2A is a schematic illustration of an elevator that stops on a given floor a single time in the course of the up-down cycle of the elevator, in accordance with some applications of the present invention;

FIG. 2B is a flowchart showing an algorithm that is used to determine the time interval until the elevator is scheduled to next stop on a given floor, for use with the elevator system as shown in FIG. 2A, in accordance with some applications of the present invention;

FIG. 3A is a schematic illustration of an elevator that stops on a given floor twice during each up-down cycle, in accordance with some applications of the present invention; and

FIG. 3B is a flowchart showing an algorithm that is used to determine the time interval until the elevator is scheduled to next stop on a given floor, for use with the elevator system as shown in FIG. 3A, in accordance with some applications of the present invention.

### DETAILED DESCRIPTION OF EMBODIMENTS

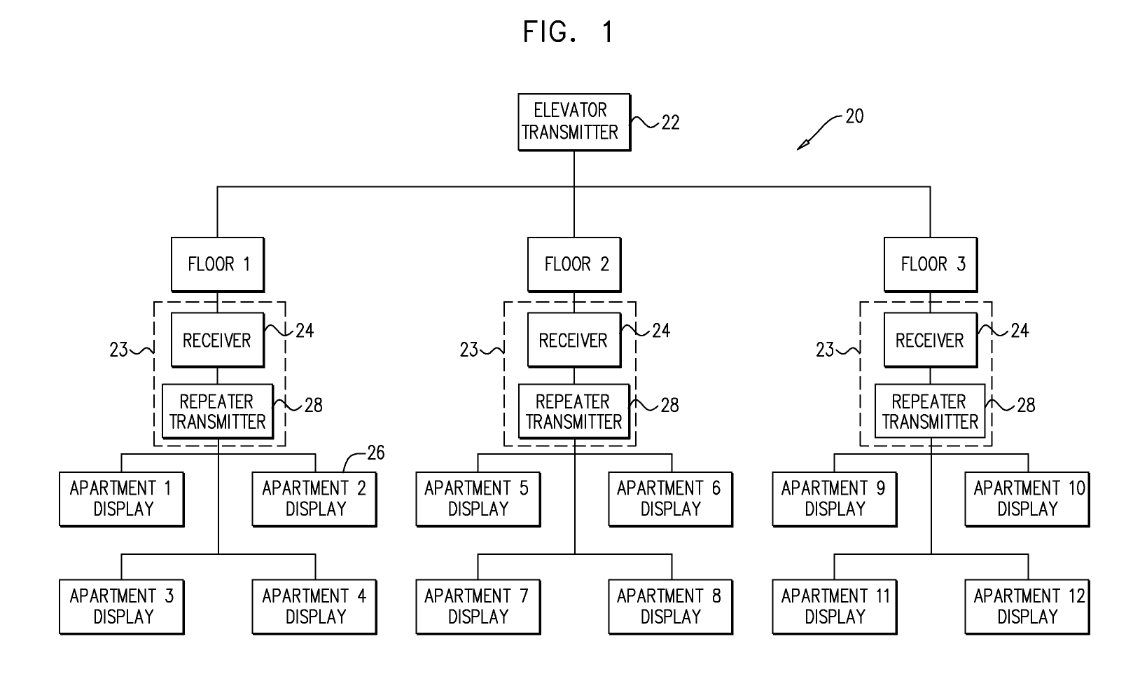

Reference is now made to FIG. 1, which is a block diagram of a timer system 20 for use with a Shabbat elevator, in accordance with some applications of the present invention. An elevator transmitter 22 is placed in the vicinity of the elevator (e.g., inside the elevator, or on the roof of the elevator). Typically, there is a repeater 23 that includes a receiver 24 and a repeater transmitter 28 (e.g., within a single housing), on each floor of the building. When the elevator arrives at a given floor (e.g., floor 1), the elevator sends a signal to the repeater on the floor. In response to the signal, a control unit determines the time interval until the elevator will next reach the floor. In response thereto, one or more display units 26 (e.g., clocks placed in respective apartments of the floor) display a countdown timer showing the time until the elevator is next predicted to be at the floor.

Elevator transmitter 22, which as described hereinabove is placed in the vicinity of the elevator, typically includes an accelerometer and/or gyro meter and/or barometer. For some applications, the elevator transmitter transmits a signal (of, for example, 2 to 10 seconds length) in response to the accelerometer and/or gyrometer and/or barometer detecting that the elevator was moving and has now stopped. For some applications, there is a delay (of, for example, between 3 and 20 seconds, e.g., between 5 and 15 seconds) between the accelerometer and/or gyrometer and/or barometer detecting that the elevator has stopped and the transmission of the signal, in order to allow time for the elevator doors to open. Alternatively, transmitter transmits a signal at a regular time interval (e.g., every 10 to 30 seconds), or generally continuously, irrespective of data that are sensed by an accelerometer, gyrometer or a barometer.

For some applications, elevator transmitter 22 is manually switched on before Shabbat and switched off after Shabbat (e.g., via a button on the transmitter, or via remote control). Alternatively, the accelerometer and/or the gyrometer and/or barometer is configured to detect when the elevator is in Shabbat mode (e.g., by detecting that the elevator stops and starts in accordance with a fixed time cycle), and the transmitter is configured to operate in response thereto.

Receiver 24 of repeater 23 typically but not necessarily receives the signal from elevator transmitter 22 only if the transmitter is within a given distance of the receiver (e.g., within 5 meters, or within 3 meters). Further typically, transmitter 22 only transmits a short-range signal. Thus, receiver 24 only receives the signal if the elevator is on the floor on which the receiver is placed. Typically, a plurality of repeaters 23 are placed on respective floors of the building, as shown in FIG. 1. In response to receiver 24 receiving the signal that the elevator is on the floor on which the receiver is placed, repeater transmitter 28 transmits a second signal that is longer range than the signal that was transmitted by elevator transmitter 22. Typically, repeater transmitter 28 transmits the second signal at a different frequency from the frequency at which the elevator transmitter transmits the first signal to the repeater. Further typically, repeater transmitters 28 of respective floors transmit second signals at respective frequencies (or respective other signal parameters), such that, for example, a signal that is transmitted by a repeater on floor 3 is not interpreted by a display unit on floor 2 as meaning that the elevator is at floor 2.

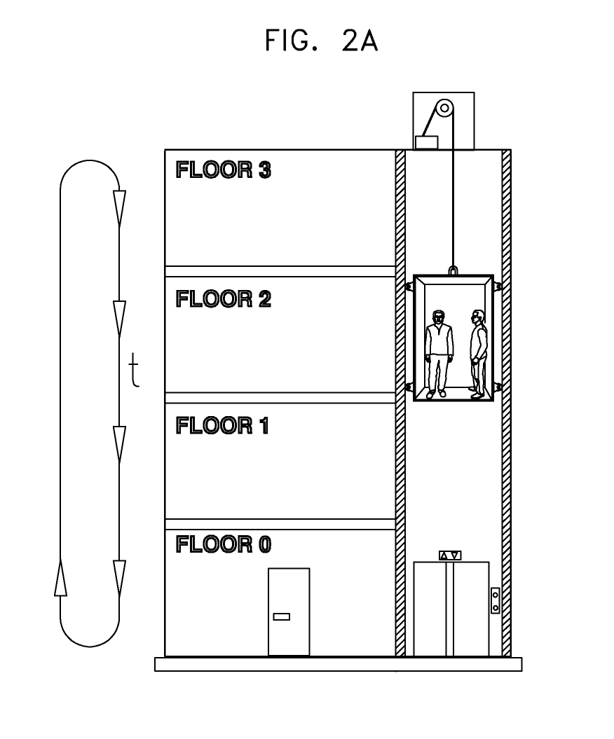

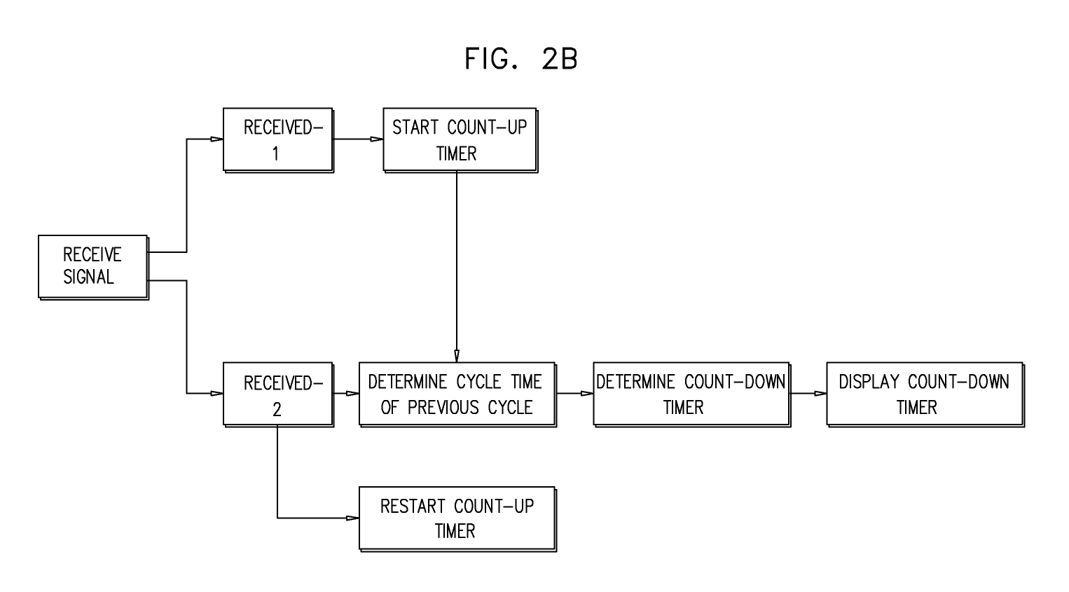

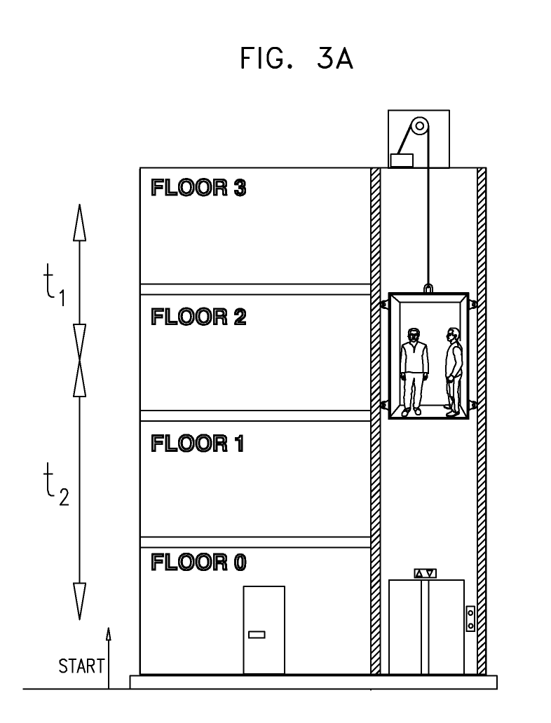

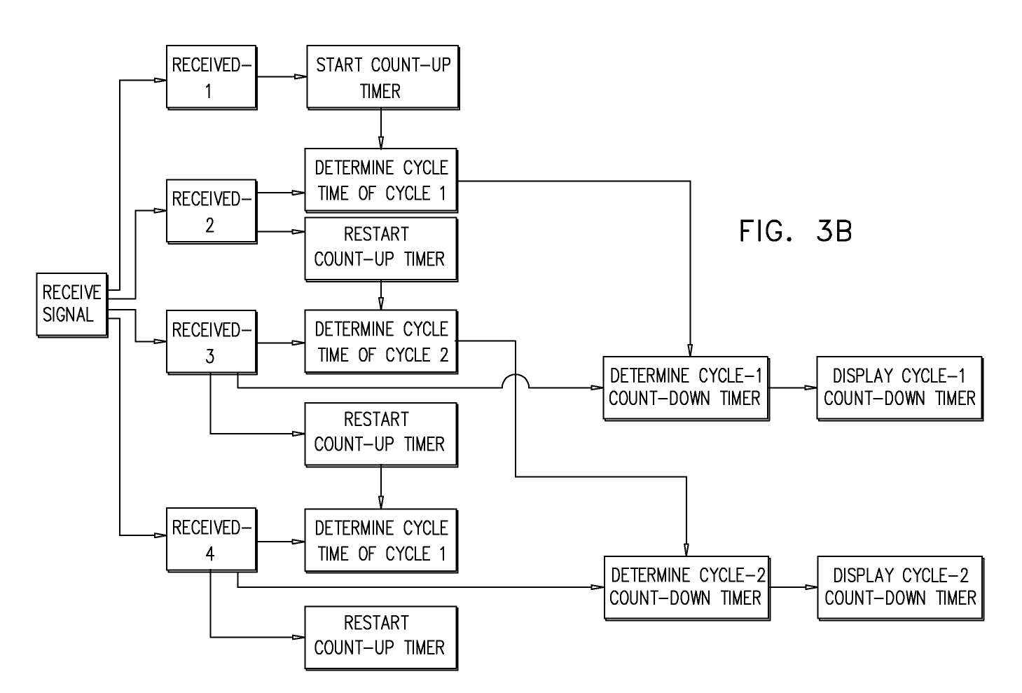

For some applications, a control unit is coupled to repeater 23. The control unit determines when the elevator will next be on the floor (typically in accordance with the algorithms described with reference to FIGS. 2 and 3) and repeater transmitter 28 transmits an encoded signal containing data relating to the estimated next arrival time of the elevator. The display units are configured to receive these data at given time intervals, and to update a countdown timer that is displayed on the display in response thereto. For example, by way of illustration and not limitation, the repeater may transmit one signal each second (or one signal every several seconds) that contains the current countdown time until the estimated next arrival of the elevator, and the display units may be configured to receive the signal from the repeater between once every 10 seconds and once every 10 minutes, or between once every five minutes and once every 15 minutes.

Alternatively, the second signal that is transmitted by the repeater transmitter is encoded only with the data relating to the floor on which the repeater is disposed (i.e., by transmitting at a frequency that is characteristic of repeaters on that floor, as described hereinabove). The second signal that is transmitted by the repeaters of a given floor is received by the display units that are on the floor. In response to receiving the signal, a control unit that is coupled to the display unit (e.g., that is disposed inside the display unit) determines when the elevator will next be on the floor (typically in accordance with the algorithms described with reference to FIGS. 2 and 3).

For some applications, repeater 23 is manually switched on before Shabbat and switched off after Shabbat (e.g., via a button on the repeater, or via a remote control). Alternatively, the repeater switches off automatically in response to not having received a signal from the elevator transmitter for a given time period.

For some applications, before using a display unit, a user designates the frequency at which the display unit will receive the signal from the repeater, to correspond with the frequency at which the repeater of the appropriate floor transmits. For example, the user may designate the frequency by pressing buttons that are disposed on the display unit and/or the repeater, in accordance with techniques that are known in the art. Alternatively, the display unit detects at which frequency the display unit is receiving the strongest signal, and interprets this as being the frequency of the repeater on its floor.

For some applications, a plurality of repeaters are disposed on a given floor. For example, on a floor of a hotel that contains many rooms, several repeaters may be used in order to relay the signal to rooms that are at a large distance from the elevator.

For some applications, the control unit that runs the algorithms is operatively coupled to display units 26, as described hereinabove. This configuration is such that the first signal (which transmitter 22 sends receiver 24), and the second signal (which repeater transmitter 28 sends display unit 26) is typically encoded to contain data regarding the floor on which the repeater is disposed, but not to contain data regarding the timing of the elevator's estimated arrival.

Alternatively, as described hereinabove, the control unit may be operatively coupled to the repeater of each floor. In response to the repeater detecting a signal that is indicative of the fact that the elevator is at its floor (as described hereinabove), the control unit runs an algorithm to determine when the elevator will next be at the floor. In response thereto, the repeater transmitter sends an RF signal encoded with the estimated arrival time of the elevator. The display unit receives the encoded signal, decodes the estimated arrival time and displays a countdown timer with the estimated time.

Further alternatively, the control unit is operatively coupled to a different component of system 20. For example, for some applications, the control unit may be operatively coupled to elevator transmitter 22. For some applications, an accelerometer and/or a gyrometer and/or a barometer that is coupled to the elevator transmitter is configured such that the accelerometer and/or the gyrometer and/or the barometer is able to detect which floor the elevator is currently on. Alternatively, the elevator transmitter detects which floor it is at, by receiving a signal from the repeater on the floor, the signals transmitted by repeaters of respective floors being transmitted at respective frequencies, as described hereinabove. In response to the transmitter receiving a signal from the accelerometer, the gyrometer, the barometer and/or the repeater indicating that the elevator is at a given floor, the control unit of the transmitter determines when the elevator will next be at the floor. The transmitter then sends an RF signal encoded with the estimated arrival time of the elevator at the floor. Repeater 23 amplifies the signal to relay it to the display units of the floor. The display units receive the encoded signal, decode the estimated arrival time and display a countdown timer with the estimated time.

It is noted that installation of system 20, as described hereinabove, typically does not require access to the operating system of the elevator. Rather the system may be installed in any elevator and may determine the cycle time(s) of the elevator by running the algorithms described hereinbelow with reference to FIGS. 2-3. In order to install the system, the following steps may be required:

1) Coupling elevator transmitter 22 to the elevator (e.g., by sticking or screwing the transmitter to the elevator).

2) Placing repeater 23 on each floor (or some floors) in the vicinity of the elevator.

3) Optionally, pairing display units 26 of each floor with the repeater of that floor, as described hereinabove.

4) Optionally, setting the display unit to be on single-cycle setting (for use with an elevator as shown in FIG. 2A), or two-cycle setting (for use with an elevator as shown in FIG. 3A). (Alternatively, the display unit, the repeaters, the elevator transmitter, and/or another component of the system may be configured to detect automatically whether the elevator operates according to a single cycle or according to two cycles.)

In alternative applications, the timer system is integrated with the operating system of the Shabbat elevator. In accordance with such applications, display units 26 are integrated with the Shabbat-elevator operating system. The operating system determines when the elevator will next be at each floor based upon the programming instructions of the elevator, and the display units display this information.

For some applications, display unit 26 comprises a clock. For example, the clock may comprise an analogue clock for showing the time, and a digital LCD display for showing the elevator countdown timer. For some applications, the clock includes an alarm (e.g., a visible alarm, such as flashing LED lights, or an audible signal) that is triggered in response to the countdown timer indicating that the elevator is estimated to arrive within a given time period (e.g., within a time period of between seconds and one minute). For some applications, the display unit is configured to switch off in response to not having received a signal from repeater 23 for a given time period (e.g., for a time period of between 10 minutes and minutes, or between 30 minutes and 60 minutes). Alternatively, the repeater switches off the display units by transmitting a signal to the display units, in response to the repeater detecting that the elevator is no longer running in Shabbat mode (in accordance with the techniques described hereinabove). Thus, when the elevator is no longer running on Shabbat mode, the display unit automatically stops displaying the countdown timer.

In accordance with respective applications, the display unit (and/or other components of the system) may be powered by disposable batteries, rechargeable batteries, solar power, mains electricity, or another form of power, in accordance with the power requirements of the display unit and/or other considerations.

Reference is now made to FIG. 2A, which is a schematic illustration of an elevator 30 that stops on a given floor a single time in the course of the up-down cycle of the elevator (i.e., a single-cycle elevator), as shown schematically in FIG. 2A. (Alternatively, some elevators stop at each floor (or at selected floors) twice in the course of the up-down cycle of the elevator; once during the ascent and once during the descent of the elevator, as described with reference to FIG. 3A.) Although the elevator is shown in FIG. 2A as stopping on floors of the building during the descent of the elevator, the techniques described herein with respect to FIG. 2B could be applied to an elevator that stops on each floor during the ascent of the elevator, and then descends to the lobby of the building without stopping.

For some applications, the control unit runs an algorithm as shown in FIG. 2B when timer system 20 is used with a single-cycle elevator. It is noted that the algorithm is described with respect to an application in which the control unit is operatively coupled to the display unit, and receives a signal from repeater 23 that is not encoded with the estimated arrival time of the elevator. Similar algorithms could be implemented if the control unit is coupled to the transmitter 22, or repeater 23 (as described hereinabove), mutatis mutandis.

In response to receiving a first signal from repeater indicating that the elevator is on the floor on which the display unit is disposed, the control unit starts a count-up timer. The purpose of the count-up timer is to determine the cycle time of the elevator. In response to receiving a second signal that the elevator is on the floor (indicating that the elevator has completed a cycle), the control unit determines the cycle time of the previous cycle. The control unit thereby estimates the time until the next arrival of the elevator at the floor (i.e., what should be displayed on the count-down timer). In response thereto, the display unit displays the count-down timer. In response to receiving the second signal that the elevator is at the floor, the control unit typically restarts the count-up timer. In response to receiving a third signal that the elevator is at the floor, the steps described with reference to the second signal are typically repeated.

For some applications, the control unit only calculates the cycle time of the elevator for a given number of cycles (e.g., 2 to 10 cycles). In response thereto, the control unit determines a characteristic cycle time, e.g., (a) the shortest cycle time in the last given number of cycles, or (b) the typical (e.g., mean) elevator cycle time of the last given number of cycles. During subsequent cycles, the control unit does not calculate the elevator cycle time. Rather, the control unit determines the estimated arrival time of the elevator based upon the characteristic elevator cycle time. For some applications, the control unit conserves energy by using the characteristic elevator cycle time rather than calculating the elevator cycle time every cycle. In addition, by using the characteristic elevator cycle time, the control unit can estimate the next arrival time of the elevator even in situations in which the elevator had an atypical previous cycle, e.g., if someone held the elevator on a given floor for longer than the time for which the elevator is typically at the given floor. For some applications, the characteristic elevator cycle time is re-determined (by performing the steps described with reference to FIG. 2B) periodically, or in response to a change in the programming of the Shabbat elevator cycle.

For some applications, the control unit calculates the next arrival time of the elevator, based upon the determined characteristic cycle time, as described hereinabove. In addition, the control unit determines the length of the previous cycle, in accordance with the techniques described hereinabove. The control unit compares the length of the characteristic cycle time to the length of the previous cycle.

If, a given number of consecutive cycles (e.g., three or more cycles, or five or more cycles), have cycle times that:
are substantially similar to each other (e.g., they differ from each other by less than 2-5 seconds), and
differ from the previously determined characteristic cycle time by more than a given amount (e.g., 5-15 seconds, or 15 seconds to one minute),

then the control unit determines a new characteristic cycle time, based upon the cycle times of the consecutive cycles. Thus, if the cycle time of the elevator changes permanently (for example, due to the elevator cycle being reprogrammed), the characteristic cycle time which is used to calculate the estimated arrival time of the elevator will be automatically updated.

Furthermore, since in general, the control unit uses the characteristic cycle time to estimate the next arrival of the elevator, the estimated arrival time of the elevator is relatively accurate, even in situations in which the elevator had an atypical previous cycle, as described hereinabove.

Reference is now made to FIG. 3A, which is a schematic illustration of an elevator that stops on a given floor twice during each up-down cycle, in accordance with two subcycles, in accordance with some applications of the present invention. Some Shabbat elevators stop at each floor (or at selected floors) of a building twice in each up-down cycle; once during the ascent of the elevator and once during the descent of the elevator. As shown in FIG. 3A, for such systems, there are two cycle times which are calculated by timer system 20. t1 is the cycle time of cycle 1, which is the subcycle of the elevator from when it passes a given floor (e.g., floor 2, as shown) during the ascent of the elevator, until it reaches the given floor during the descent of the elevator. (As indicated in FIG. 3A, this is the first cycle that the elevator undergoes in Shabbat-mode, assuming that the starting position of the elevator when the elevator entered Shabbat-mode was on the ground floor.) t2 is the cycle time of cycle 2, which is the subcycle of the elevator from when it passes a given floor (e.g., floor 2, as shown) during the descent of the elevator, until it reaches the given floor during the ascent of the elevator.

Reference is now made to FIG. 3B, which is a flowchart showing an algorithm that is used to determine the time interval until the elevator is scheduled to next stop on a given floor, for use with the elevator system as shown in FIG. 3A, in accordance with some applications of the present invention. The algorithm that is shown in FIG. 3B facilitates the calculation of the estimated next arrival time of the elevator (a) when the elevator will next be passing the floor during the descent of the elevator, i.e., at the end of cycle 1, and (b) when the elevator will next be passing the floor during the ascent of the elevator, i.e., at the end of cycle 2. In all other aspects, the control unit estimates the next arrival time of the elevator in a similar manner to that described with reference to FIG. 2B, mutatis mutandis. For example, the control unit may determine characteristic cycle times of the elevator, and may automatically update the characteristic cycle time, as described with reference to FIG. 2B.

In response to receiving a first signal from repeater indicating that the elevator is on the floor on which the control unit is disposed, the control unit starts a count-up timer. The purpose of the count-up timer is to determine the cycle time of the elevator.

Receipt of a second signal that the elevator is on the floor indicates that the elevator has completed cycle 1 and is about to undergo cycle 2. In response to receiving a second signal that the elevator is on the floor, the control unit determines the cycle time of the previous cycle 1. In addition, in response to receiving the second signal that the elevator is on the floor, the count-up timer is restarted.

Receipt of a third signal that the elevator is on the floor indicates that the elevator has completed cycle 2 and is about to undergo cycle 1 again. In response to receiving a third signal that the elevator is on the floor, the control unit determines the cycle time of the previous cycle 2. In addition, the control unit estimates the time until the next arrival of the elevator at the floor (i.e., what should be displayed on the count-down timer), based upon the elevator having just arrived at the floor, and based upon the determined cycle-time of cycle 1. In response thereto, the display unit displays the count-down timer. In addition, in response to receiving the third signal that the elevator is on the floor, the count up timer is restarted.

Receipt of a fourth signal that the elevator is on the floor indicates that the elevator has completed cycle 1 and is about to undergo cycle 2 again. In response to receiving a fourth signal that the elevator is at the floor, the control unit determines the cycle time of the previous cycle 1. In addition, the control unit estimates the time until the next arrival of the elevator at the floor (i.e., what should be displayed on the count-down timer), based upon the elevator having just arrived at the floor, and based upon the determined cycle-time of cycle 2. In response thereto, the display unit displays the count-down timer. In addition, in response to receiving the fourth signal that the elevator is on the floor, the count-up timer is restarted.

For some applications, the steps described hereinabove as being performed in response to the third and fourth signals, are performed in response to further signals that are received by the control unit. For some applications, characteristic cycle times of the cycles 1 and 2 are determined and the techniques described with reference to FIG. 2B are applied to an elevator having two sub-cycles (as shown in FIG. 3A), mutatis mutandis.

For some applications, on each floor (or on selected floors) of a building a transmitter is coupled to the door(s) of the elevator. The transmitters detect when the elevator arrives at respective floors, by detecting that the elevator door(s) has opened at that floor. For example, the transmitter may be coupled to an accelerometer and/or a gyrometer and/or a barometer that detects the opening of the door(s), or a contact sensor (e.g., a magnetic contact sensor) may detect the opening of the door(s). In accordance with respective applications, in response to detecting that the elevator is at its floor, the transmitter sends a signal to the repeaters on its floor, or sends a signal directly to the display units on its floor. As described hereinabove, the control unit for determining the estimated next arrival time of the elevator may be operatively coupled to the transmitter, the repeater and/or to the display units. In all aspects other than the transmitter detecting the arrival of the elevator at a given floor by detecting the opening of the elevator door(s), such applications are generally similar to the applications described hereinabove.

For some applications, timer system 20 determines the estimated next arrival time of the elevator at a given floor, in accordance with the techniques described hereinabove. Data relating to the estimated arrival time are then transmitted to the display devices (e.g., personal computers, cellular phones, and/or personal digital assistants) through a TCP/IP or an alternative protocol. In response thereto, the display devices display the estimated arrival time of the elevator. Alternatively, data are sent to the display devices via a TCP/IP or an alternative protocol indicating that the elevator has arrived at a given floor. In response thereto, the display devices determine the estimated next arrival time of the elevator (in accordance with the techniques described hereinabove) and display this information.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. Apparatus for use with a Shabbat-elevator inside a building, the apparatus comprising:
an elevator transmitter configured to be placed in a vicinity of the elevator and to transmit a signal;
at least one repeater configured to be placed on a given floor of the building, the repeater comprising a receiver that is configured to receive the signal from the transmitter, when the elevator is at the given floor;
a control unit configured, in response to the signal, to determine a time interval until the elevator is predicted to next be at the given floor; and
a display unit configured to display an indication of when the elevator is predicted to next be at the given floor, based upon the determined time interval.

2. The apparatus according to claim 1, wherein the elevator includes an elevator that stops at the given floor a single time in an up-down cycle of the elevator, and wherein the control unit is configured to estimate the time interval until the elevator that stops the single time is predicted to next be at the given floor.

3. The apparatus according to claim 1, wherein the elevator includes an elevator that stops at the given floor twice in an up-down cycle of the elevator, and wherein the control unit is configured to estimate the time interval until the elevator that stops twice is predicted to next be at the given floor.

4. The apparatus according to claim 1, wherein the display unit is configured to display a timer that counts down to an estimated time of the next arrival of the elevator at the floor.

5. The apparatus according to claim 1, wherein the transmitter is configured to transmit the signal by transmitting a short-range signal that is such that the repeater only receives the signal when the elevator is on the given floor.

6. The apparatus according to claim 1, wherein:
the control unit is operatively coupled to the display unit,
the repeater is configured to transmit a signal to the display unit indicating that the elevator is at the given floor; and
the control unit is configured to receive the signal and estimate the time interval until the elevator is predicted to next be at the given floor, in response thereto.

7. The apparatus according to claim 1, wherein:
the control unit is operatively coupled to the repeater,
the transmitter is configured to transmit the signal by transmitting a signal indicating that the elevator is at the given floor,
the repeater is configured to receive the signal, and the control unit is configured to estimate the time interval until the elevator is predicted to next be at the given floor, in response thereto; and
the repeater is configured to transmit an encoded signal to the display unit, the encoded signal containing an indication of when the elevator will next be at the given floor.

8. The apparatus according to claim 7, wherein the repeater is configured to amplify the encoded signal and transmit the amplified encoded signal to the display unit.

9. The apparatus according to claim 1, wherein the repeater comprises a plurality of repeaters disposed on respective floors of the building.

10. The apparatus according to claim 9, wherein the repeaters of the respective floors are configured to transmit signals having respective signal parameters, and wherein the display units of a given floor are configured to receive signals having parameters that correspond to the signal transmitted by the repeater on the same floor as the display units.

11. The apparatus according to claim 1, wherein the control unit is configured to determine the time interval by calculating a time interval between consecutive previous arrivals of the elevator at the floor.

12. The apparatus according to claim 11, wherein the control unit is configured to determine a characteristic elevator cycle time based upon a plurality of time intervals between respective, consecutive arrivals of the elevator at the floor, and wherein the control unit is configured to determine the time interval until the elevator is predicted to next be at the floor, based upon the characteristic elevator cycle time.

13. The apparatus according to claim 12, wherein the control unit is configured to determine the characteristic elevator cycle time by determining a mean time interval of the plurality of time intervals.

14. The apparatus according to claim 13, wherein the control unit is configured to determine the characteristic elevator cycle time by determining a minimum time interval of the plurality of time intervals.

15. A method for use with a Shabbat-elevator inside a building, the method comprising:
in response to the elevator arriving at a given floor of the building, receiving a signal;
in response to receiving the signal, determining a time interval until the elevator is predicted to next be at the given floor; and
displaying an indication of when the elevator is predicted to next be at the given floor, based upon the determined time interval.

16. The method according to claim 15, wherein receiving the signal comprises receiving signals having respective parameters, in response to the elevator arriving at respective floors.

17. The method according to claim 15, wherein the elevator includes an elevator that stops at the given floor a single time in an up-down cycle of the elevator, and wherein determining the time interval comprises determining a time interval until the elevator that stops the single time is predicted to next be at the given floor.

18. The method according to claim 15, wherein the elevator includes an elevator that stops at the given floor twice in an up-down cycle of the elevator, and wherein determining the time interval comprises determining a time interval until the elevator that stops twice is predicted to next be at the given floor.

19. The method according to claim 15, wherein displaying the indication comprises displaying a timer that counts down to an estimated time until the next arrival of the elevator at the floor.

20. The method according to claim 15, wherein receiving the signal comprises transmitting a short-range signal that is such that a repeater on the given floor only receives the signal when the elevator is on the given floor.

21. The method according to claim 15, wherein determining the time interval comprises:
transmitting a signal to a display unit indicating that the elevator is at the given floor; and
at the display unit, receiving the signal and, in response thereto, estimating the time interval until the elevator is predicted to next be at the given floor,
wherein displaying the indication comprises displaying the indication at the display unit.

22. The method according to claim 15, wherein:
determining the time interval comprises determining the time interval at a repeater on the given floor, and transmitting an encoded signal to a display unit, the encoded signal containing an indication of when the elevator will next be at the given floor, and
displaying the indication comprises displaying the indication at the display unit.

23. The method according to claim 22, wherein transmitting the encoded signal comprises amplifying the encoded signal and transmitting the amplified encoded signal to the display unit.

24. The method according to claim 15, wherein determining the time interval comprises determining the time interval by calculating a time interval between consecutive previous arrivals of the elevator at the floor.

25. The method according to claim 24, wherein determining the time interval comprises determining a characteristic elevator cycle time based upon a plurality of time intervals between respective, consecutive arrivals of the elevator at the floor, and determining the time interval until the elevator is predicted to next be at the floor, based upon the characteristic elevator cycle time.

26. The method according to claim 25, wherein determining the characteristic elevator cycle time comprises determining a mean time interval of the plurality of time intervals.

27. The method according to claim 25, wherein determining the characteristic elevator cycle time comprises determining a minimum time interval of the plurality of time intervals.

28. A method for use with a Shabbat-elevator inside a building, the method comprising:
receiving a signal that is indicative of the elevator having arrived at a given floor of the building;
in response to receiving the signal, determining a time interval until the elevator is predicted to next be at the given floor; and
displaying an indication of when the elevator is predicted to next be at the given floor, based upon the determined time interval.

29. The method according to claim 28, wherein determining the time interval comprises determining the time interval even without accessing an operating system of the elevator.
